(19) United States
(12) Patent Application Publication
(10) Pub. No.: US 2003/0185259 A1
(43) Pub. Date: Oct. 2, 2003

(54) Frequency identification with frequency locker

(76) Inventors: Claude Gamache, Nepean (CA); Bernard Villeneuve, Aylmer (CA); Michel Cyr, Hull (CA); Simon Roy, Sainte-Foy (CA)

Correspondence Address: LAHIVE & COCKFIELD, 28 STATE STREET, BOSTON, MA, 02109, US

(21) Appl. No.: 10/108,856

(22) Filed: Mar. 29, 2002

(51) Int. Cl. H01S 3/098; H01S 3/10; H01S 3/13

(52) U.S. Cl. 372/32; 372/29.02; 372/20; 372/18

(57) ABSTRACT

An apparatus and a method is provided for frequency identification and laser locking by sending optical signals of a laser through a set of optical filters. The signal power transmitted by the filters is measured and the resulting set of powers normalized with respect to a reference power. The multidimensional measurement output curve of the set of filters is nondegenerate. The set of measurements is compared to a set of points in a calibration table or constellation, which results in the identification of the frequency of the laser.

### FIELD OF THE INVENTION

The invention relates to optical signal frequency measurement and more particularly to optical laser frequency identification and locking.

### BACKGROUND OF THE INVENTION

Laser transmitters, whether they are tunable or single frequency, have an undetermined frequency when they are first powered up. In optical telecommunications systems this uncertainty is unacceptable since a new transmitter being powered up can potentially emit light on an already used frequency channel in the system and therefore corrupt data being transmitted on that frequency channel. For that reason, it is necessary to ensure that the frequency of the laser transmitter is known prior to having any significant amount of light reaching the transmission link.

It is also important once a laser is powered up and operating in the telecommunications system, that the frequency of its output is constantly kept within a certain frequency channel for example its ITU (international telecommunications union) channel. Maintaining environmental conditions of operation constant can help to reduce instability in the frequency of the output, but frequencies of lasers may change with age and for various reasons may drift while in operation. In order to fully guard against frequency drift for what ever reason, laser locking is required to keep the laser outputting at the correct frequency.

The first opportunity for ensuring or predicting the frequency behavior of a laser is shortly after production. As a first step some determination of the general frequency behavior of the particular laser in question whether DFB (distributed feedback) lasers or tunable lasers, DBR (Distributed Bragg Reflector) tunable lasers, TGC (tunable gain coupled) tunable lasers or MEMS (micro-electromechanical systems) tunable lasers for example is made. The results are subsequently stored usually in a look-up table or data table. In the case of a DFB laser, the laser's frequency versus temperature and current is determined. In the case of a tunable laser, and particularly a MEMS tunable laser, the frequency versus voltage and current is determined. It should be noted that in the case of a MEMS tunable laser this frequency dependence is a rough determination as the frequency behavior cannot be reliably predicted. This process of production measurement of a laser is normally time consuming and expensive requiring the use of a standard external wavemeter to take a large number of measurements. The resulting data table provides a rough estimate of the frequency of a laser under certain operating conditions, which can be used as a starting point during start up procedures.

A DFB laser is a single frequency laser which can be tuned within a small range of frequencies (500 to 800 GHz) by varying the temperature and current. Although a DFB laser constructed for use within a particular frequency channel will be within tuning range of its desired frequency through temperature and current variation, there is no absolute guarantee that the DFB laser will be within its prescribed frequency channel when it is first powered up. Currently, a laser front locker layout such as that indicated in FIG. 1 is used for laser locking where the laser could be a DFB, TGC or MEMS tunable laser for example. A laser front locker uses a portion of the light emitted from the front of a laser 10 to measure the frequency and lock the laser 10. It should be noted that rear facet Locker assemblies are also common, in which the signals emitted from the rear facet of a laser are used for frequency measurement and laser locking. A laser has its output typically pass through a first asphere lens 11 which is then split by a first beam splitter 25, the transmitted portion of which (generally 90% of the signal) continues through a GRIN lens 12 over an optical waveguide portion 13 to an optical attenuator 20, optical switch or optical shutter. Before the laser has been locked, the optical attenuator 20 blocks signals from reaching the fiber span 15 and potentially contaminating the telecommunications system. Some type of attenuator or switch i.s; required for both standard front and rear facet lockers. Once the laser has been locked, the transmitted portions of the signals are permitted to pass through the optical attenuator 20 and along the fiber span 15 to be used in the telecommunications system. The portion of an optical signal reflected from the first beam slitter 25 (generally 10% of the signal) is directed to a second beam splitter 26. The signal transmitted through the second beam splitter 26 (typically 35% of the signal incident on the second beam splitter 26) continues to a reference photodetector 35 which also acts as a power monitor. The signal reflected from the second beam splitter 26 (typically 65% of the signal incident on the second beam splitter 26) passes through a multi-wavelength etalon filter 30 (for example a Fabry-Perot glass etalon). The signals transmitted through the multi-wavelength etalon filter 30 are measured by an etalon photodetector 36. Referring also to FIG. 2, the free spectral range (FSR) of the multi-wavelength etalon filter is typically quite small, on the order of 100 GHz, and the finesse (which is the ratio of the FSR to the width of a transmission peak at 50%) is around 2.0 since the width of the peaks at 50% is about 50 GHz. Generally the etalon filter 30 chosen will have a transmission curve (labeled ETALON in the figure) which has a sloped region (as opposed to a local maximum or local minimum) coinciding with the desired laser locking frequency F and ideally the desired frequency is about halfway between a local maximum and a local minimum of the transmission curve of the etalon. According to laser locking principles well known in the art, the process of locking the laser involves dividing the photocurrent of the etalon photodetector (labeled ETALON) by the photocurrent of the reference photodetector (labeled REF), to generate a photocurrent ratio. Etalons have been traditionally chosen for this purpose because the steeply sloped region between peaks of its transmission curve enables more accurate frequency determination and has a high AM to FM conversion. A frequency region about the desired laser locking frequency F of roughly, ±40% to ±50% of the FSR of the multi-wavelength etalon filter serves as a locking acquisition range. There is only one point on the transmission curve within the locking acquisition range which has a photocurrent ratio which corresponds to the locking ratio, indicating that the laser frequency is correct. In FIG. 2 the locking ratio is 1 although in general, this is not the case. The choice of the beam splitting ratio of the second beam splitter 26, namely 35% to 65%, helps to bring the photo-currents of the reference photodetector and the second photodetector closer to equality near the locking frequency, and hence the locking ratio in this case is close to 1. Before the locking procedure is commenced the laser frequency must be brought within locking acquisition range of the locking point. As can be seen in FIG. 2, currently the use of an etalon filter in this manner leads to a number of possible locking points. The photocurrent ratio at frequencies which are a multiple of 100 GHz above or below F is the same as the locking ratio at F, as is also the photocurrent ratio of frequencies near multiples of 100 GHz above or below F plus approximately 50 GHz. This leads to a degeneracy which cannot be distinguished from the proper locking frequency by measuring the photocurrent ratio, or the individual photocurrents themselves. This degeneracy of values in the transmission curve combined with the uncertainty of the starting transmission frequency of the laser, makes it important to ensure that the laser is within the locking acquisition range so that it locks to the proper locking point and not a point having the same ratio lying outside of the locking acquisition range. In the past the relatively large channel spacing and the relatively narrow tuning range of the DFB lasers combined to present a very small probability that the frequency of a laser would be dangerously close to the wrong channel or far outside the proper locking acquisition range. The reduction of channel spacing however has given rise to a larger likelihood of encountering this problem introducing a new problem which warrants a solution. Currently, a very common and cost effective approach, is not to check that the frequency of the laser is within the proper locking acquisition range before locking the laser. In this approach, the frequency is measured during fabrication of the laser transmitter card, after which it is assumed that the look-up table will be a good enough predictor of the behavior of the laser. This approach is becoming less and less effective, and more risky as channel spacing decreases and tunable lasers become more prevalent. If more caution is required, current approaches to ensure that the frequency of the laser is within locking acquisition range involve the measurement of the frequency of the laser during start-up procedures. Frequency measurements in the field subsequent to start-up generally only occur when there is a failure or a problem which requires an operator to measure the frequency. The frequency of the laser may be measured by a standard external wavemeter (not shown) while adjusting the frequency of the laser to its proper value. Another option is to use an optical power spectrum analyzer (OSA) (not shown) to measure the frequency of the laser. These approaches require the light to be sent only to the measuring apparatus while protecting the transmission link from optical signals which may as outlined above conflict with data channels in the system. Although some protection is provided by the optical attenuator 20, when using a wavemeter or an OSA the fiber might have to be disconnected manually from the link by an operator which is costly and very time consuming. Once the frequency is measured and set to the prescribed value, the fiber can be reconnected. This is a highly undesirable way of proceeding. These examples show that current approaches are either ineffective and risky, or conversely time consuming, impractical and costly.

To avoid the use of a wavemeter or a spectrum analyzer in the case of a MEMS tunable laser, and because of the coarse estimate of the output frequency, current approaches involve sweeping the MEMS tunable laser through a wide range of frequencies until the locking acquisition range is reached. This, however, is very time consuming and as with all other current methods requires an optical attenuator or optical switch to ensure that the various frequencies swept through do not contaminate the telecommunications system. It also does not represent a single solution, only compatible with tunable lasers since DFB laser are not tunable over the large ranges required.

Once the frequency of the laser has been adjusted to be within the locking acquisition range, feedback loop circuitry 4O is employed using tho output of the reference photodetector 35 and the etalon photodetector 36 while the laser is fine tuned by varying the temperature and/or current(s), and for some lasers voltage(s), until the proper ratio is obtained, at which point the laser is continually locked at that frequency. In order to allow adjustment of the laser over the entire locking acquisition range, without risking transmission within another frequency channel, the locking acquisition ranges and hence the FSR of the etalon is typically chosen to be equal to or smaller than the channel spacing. Typically the transmission curve of a glass etalon filter will vary with temperature, so to avoid frequency drift of the locker, the etalon filter itself and hence the frequency locker should be maintained at a constant temperature. If using a temperature insensitive etalon, then there is no need for a temperature control for the locker.

Another current method of laser locking uses two etalons having an FSR equal to the channel spacing of the transmission frequencies of the telecommunications system. In this implementation a second etalon is placed between the reference photodetector and the second beam splitter which here would now have a 50% to 50% beam splitting ratio. The second etalon has the same FSR as the first, but its transmission curve is shifted in frequency with respect to the first etalon. Instead of a ratio being determined, locking in this implementation involves finding the difference between the photocurrents. In this case, the etalons are chosen so that at the desired locking frequency the difference between the photocurrents is zero. This method of locking suffers the same problems as that relying on a photocurrent ratio, namely those associated with tuning the laser within the locking acquisition range, and protecting the telecommunications system from signal contamination. A variation of this method of locking a DFB laser is found in U.S. Pat. No. 5,825,792. Instead of two etalons, a single etalon is employed. The etalon is placed at an angle between two beams from the laser, and the two photodetectors behind the etalon. The angle of the etalon is chosen such that one beam passes through at a first angle while the second beam passes through at a different angle. Since the etalon has a transmission curve which shifts as a function of angle, the resulting photocurrents of the two photodetectors is similar to that obtained by using two etalons which a relative shift in transmission curves. As in the method described above, the difference between the photocurrents of the photodetectors is used to lock the laser.

Traditionally, an etalon, although sometimes having degeneracy in its transmission curve over large frequency ranges, has been preferred for use in laser lockers because of its steeply sloped regions with high AM to FM conversion between peaks. Typically the FSR of an etalon in laser locking was comparable to the channel spacing, which was not as small as that of modern telecommunications systems. The chosen FSR enabled high accuracy due to the slope of the curves but also introduced a potential Degeneracy. Fortunately, problems due to this degeneracy were not encountered often due to the relatively narrow frequency range of single frequency lasers in comparison with the FSR and the channel spacing. Slope filters (for example linear transmission versus frequency filters) which have a monotonic transmission curve, simply did not have a high enough slope in their transmission curves or a high enough AM to FM conversion to be preferred over etalons for use in laser lockers. As tunable lasers become more commonplace, and as channel spacing reduces, the small FSR of the Etalons have become problematic in that tunable lasers are generally tunable over larger ranges and may begin transmitting in the neighborhood of a wrong channel. Linear or slope filters have not replaced etalons because in order to span the range of tunable frequencies, its transmission curve would have a relatively low slope, which based on the traditional teaching of the field is undesirable because such replacement would result in a low accuracy in locked frequency. Conversely, if the transmission curve slope of a slope filter were steep enough for the use of the slope filter on its own in a frequency locker, its frequency range would be limited. As described above, the use of etalons has not been abandoned, which leads to degeneracy. In the context of closer channel spacing, and tunable lasers, this degeneracy a new problem, and has been overcome by the use of wavemeters and OSAs to measure the frequency of the laser, along with an optical attenuator in order to protect the telecommunications system has been adopted.

As the channel spacing of optical signals in WDM systems decreases and accuracy requirements increases, current methods for testing and locking lasers are becoming more and more difficult to implement. The neighboring channels already carrying data at start up time of the laser are closer in frequency to the target startup frequency. More care must be taken to avoid transmitting on these neighboring channels as there is less margin for error. Safe locking acquisition ranges are continually decreasing and solutions involving standard external wavemeters, OSAs and optical protection switches are expensive, time consuming and often considered unacceptable.

It would desirable for there to be a way to measure a laser during production which is cost efficient, and does not take a long period of time. It also would be desirable, for there to be single solution for determining the frequency of and locking any telecommunications laser (for example DFB, TGC, or MEMS tunable lasers) without having to implement an optical attenuator or switch to protect the telecommunications system, and which would be accurate without the use of external wavemeters or optical spectrum analyzers and moreover not require the laser to be swept through a wide range of frequencies.

### SUMMARY OF THE INVENTION

The present invention provides an apparatus and method for frequency identification and laser locking by sending optical signals of a laser through a set of optical filters. The signal power transmitted by the filters is measured by, for example, photodetectors and the resulting set of powers normalized with respect to a reference power. The set of measurements is compared to a point in a calibration table which results in the identification of the frequency of the laser.

According to a first broad aspect, the invention provides for a frequency identification apparatus for frequency identification of an optical signal having a frequency including a plurality of optical filters for producing a set of filtered optical signals from portions of the optical signal, the set of filtered optical signals having a corresponding set of filtered optical signal powers, the plurality of optical filters being such that when the frequency of the optical signal is any first frequency, the set of filtered optical signal powers together with a power of an unfiltered portion of the optical signal is different from the set of filtered optical signal powers together with the power of the unfiltered portion of the optical signal when the frequency of the optical signal is any second frequency different from the first frequency, and an optical power measuring device for measuring the set of filtered optical signal powers and generating a corresponding set of optical power measurements, and for measuring the power of the unfiltered portion of the optical signal and generating a corresponding reference optical power measurement, in which the set of optical power measurements and the reference optical power measurement uniquely identify the frequency of the optical signal.

In some embodiments of the invention the plurality of optical filters includes at least one slope filter.

Some embodiments of the invention provide for a computing device for processing the set of optical power measurements and the reference optical power measurement to generate a frequency identification of the frequency of the optical signal.

In some embodiments of the invention, the optical power measuring device includes a plurality of filter photodetectors for generating the corresponding set of optical power measurements from the set of filtered optical signals, and a reference photodetector for producing the reference optical power measurement from the unfiltered portion of the optical signal.

Some embodiments of the invention provide for a plurality of beam splitters for generating the portions of the optical signal from the optical signal and for generating the unfiltered portion of the optical signal from the optical signal, the plurality of beam splitters for providing the portions of the optical signal to the plurality of optical filters, and for providing the unfiltered portion of the optical signal to the optical power measuring device.

Some embodiments of the invention provide for a plurality of beam splitters for generating the portions of the optical signal from the optical signal and for generating the unfiltered portion of the optical signal from the optical signal, the plurality of beam splitters for providing the portions of the optical signal to said plurality of optical filters, and for providing the unfiltered portion of the optical signal to the reference photodetector.

Some embodiments of the invention provide for a walk-off reflector for generating the portions of the optical signal from the optical signal and for generating the unfiltered portion of the optical signal from the optical signal, the walk-off reflector for providing the portions of the optical signal to the plurality of optical filters, and for providing the unfiltered portion of the optical signal to the reference photodetector.

Some embodiments of the invention provide for a data table containing a constellation of the frequency identification apparatus in which the computing device processes the constellation of the frequency identification apparatus to generate the frequency identification.

In some embodiments of the invention, the computing device normalizes the set of optical power measurements with respect to the reference optical power measurement generating a set of normalized optical power measurements, and performs a comparison between the set of normalized optical power measurements and points of the constellation to generate the frequency identification.

Some embodiments of the invention provide for a data table containing a parameterized of the frequency identification apparatus, the parameterized constellation having a set of parameters in which the computing device processes the parameterized constellation of the frequency identification apparatus using a set of equations and the set of parameters to generate the frequency identification.

In some embodiments of the invention, the computing device normalizes the set of optical power measurements with respect to the reference optical power measurement generating a set of normalized optical power measurements, generates points of the constellation by use of the set of equations and the set of parameters of the parameterized constellation, and performs a comparison between the set of normalized optical power measurements and points of the constellation to generate the frequency identification.

In some embodiments of the invention, the comparison is a Euclidean smallest distance comparison.

According to second broad aspect, the invention provides for a method of identifying a frequency of an optical signal having a frequency including producing a set of filtered optical signals from portions of the optical signal, the set of filtered optical signals having a corresponding set of filtered optical signal powers, the producing the set of filtered optical signals being such that when the frequency of the optical signal is any first frequency, the set of filtered optical signal powers together with a power of an unfiltered portion of the optical signal is different from the set of filtered optical signal powers together with the power of the unfiltered portion of the optical signal when the frequency of the optical signal is any second frequency different from the fist frequency, measuring the set of filtered optical signal powers and generating a corresponding set of optical power measurements, and measuring the power of the unfiltered portion of the optical signal and generating a corresponding reference optical power measurement, in which the set of optical power measurements and the reference optical power measurement uniquely identify the frequency of the optical signal.

In some embodiments of the invention, the step of producing a set of filtered optical signals includes producing at least one slope filtered optical signal.

Some embodiments of the invention provide for processing the set of optical power measurements and the reference optical power measurement to generate a frequency identification of the frequency of the optical signal.

Some embodiments of the invention provide for generating the portions of the optical signal from the optical signal, generating the unfiltered portion of the optical signal from the optical signal, providing the portions of the optical signal for the producing a set of filtered optical signals, and providing the unfiltered portion of the optical signal for the measuring the power of the unfiltered portion of the optical signal.

Some embodiments of the invention provide for processing a constellation including normalizing the set of optical power measurements with respect to the reference optical power measurement generating a set of normalized optical power measurements, and performing a comparison between the set of normalized optical power measurements and points of the constellation to generate the frequency identification.

Some embodiments of the invention provide for processing a parameterized constellation having a set of parameters, including normalizing the set of optical power measurements with respect to the reference optical power measurement generating a set of normalized optical power measurements, generating points of the constellation by use of a set of equations and the set of parameters of the parameterized constellation, and performing a comparison between the set of normalized optical power measurements and points of the constellation to generate the frequency identification.

According to a third broad aspect, the invention provides for a frequency locker apparatus for frequency locking and for frequency identification of an optical signal of a laser having a frequency including a plurality of optical filters for producing a set of filtered optical signals from portions of the optical signal, the set of filtered optical signals having a corresponding set of filtered optical signal powers, the plurality of optical filters being such that when the frequency of the optical signal is any first frequency, the set of filtered optical signal powers together with a power of an unfiltered portion of the optical signal is different from the set of filtered optical signal powers together with the power of the unfiltered portion of the optical signal when the frequency of the optical signal is any second frequency different from the first frequency, an optical power measuring device for measuring the set of filtered optical signal powers and generating a corresponding set of optical power measurements, and for measuring the power of the unfiltered portion of the optical signal and generating a corresponding reference optical power measurement, a locking circuit for adjusting the frequency of the optical signal of the laser to a locking frequency and maintaining the frequency of the optical signal of the laser at the locking frequency as a function of the reference optical power measurement and some optical power measurements of the set of optical power measurements, in which the set of optical power measurements and the reference optical power measurement uniquely identify the frequency of the optical signal.

Some embodiments of the invention provide for a feedback circuit for controlling the frequency of the optical signal of the laser so that it is within a locking acquisition range of the locking frequency, the feedback circuit controlling the frequency of the optical signal of the laser as a function of the frequency identification.

Some embodiments of the invention provide for a data table containing a constellation of the frequency locker apparatus in which the computing device processes the constellation of the frequency locker apparatus to generate the frequency identification.

Some embodiments of the invention provide for a data table containing a parameterized constellation of the frequency locker apparatus, the parameterized constellation having a set of parameters, in which the computing device processes the parameterized constellation of the frequency locker apparatus using a set of equation and said set of parameters to generate the frequency identification.

According to as fourth broad aspect, the invention provides for a method of frequency locking a laser and identifying a frequency of an optical signal of the laser having a frequency including producing a set of filtered optical signals from portions of the optical signal, the set of filtered optical signals having a corresponding set of filtered optical signal powers, the producing of the filtered optical signals being such that when the frequency of the optical signal is any first frequency, the set of filtered optical signal powers together with the power of an unfiltered portion of the optical signal is different from the set of filtered optical signal powers together with the power of the unfiltered portion of the optical signal when the frequency of the optical signal is any second frequency different from the first frequency, measuring the set of filtered optical signal powers and generating a corresponding set of optical power measurements, measuring the power of the unfiltered portion of the optical signal and generating a corresponding reference optical power measurement, and adjusting the frequency of the optical signal of the laser to a locking frequency and maintaining the frequency of the optical signal of the laser at the locking frequency as a function of the reference optical power measurement and some optical power measurements of the set of optical power measurements, in which the set of optical power measurements and the reference optical power measurement uniquely identify the frequency of the optical signal.

Some embodiments of the invention provide for, before the step of adjusting the frequency of the optical signal of the laser to a locking frequency and maintaining the frequency of the optical signal of the laser at the locking frequency, controlling the frequency of the optical signal of the laser as a function of the frequency identification so that it is within a locking acquisition range of the locking frequency.

In some embodiments of the invention, the step of controlling the frequency of the optical signal of the laser includes repeatedly powering up the laser so that it transmits the optical signal for a duration which is insignificant to the functioning of a telecommunications system, and varying the frequency of the optical signal of the laser as a function of the frequency identification until it is within a locking acquisition range of the locking frequency.

Other aspects and features of the present invention will become apparent to those of ordinary skill in the art upon review of the following description of specific embodiments of the invention in conjunction with the accompanying figures

### BRIEF DESCRIPTION OF THE DRAWINGS

Preferred embodiments of the invention will now be described with reference to the accompanying diagrams, in which:

FIG. 1 is a block diagram of a typical prior art laser front locker;

FIG. 2 is a graph illustrating standard laser locking showing plots of photocurrent versus frequency for the photodetectors of FIG. 1;

FIG. 3 is a block diagram of a rear facet locker assembly constructed according to the invention;

FIG. 4 is a block diagram of a compact front locker assembly constructed according to the invention;

FIG. 5 is a block diagram of an external locker module constructed according to the invention;

FIG. 6 is a block diagram of a calibration set-up for calibrating the external locker module depicted in FIG. 5;

FIG. 7 is a graph depicting the transmission curves of the etalons and the linear transmission filter (LTF) of the rear facet locker assembly depicted in FIG. 3;

FIG. 8 is a perspective view of a graph depicting a 2D projection of the constellation of only the two etalons of the rear facet locker assembly depicted in FIG. 3;

FIG. 9 is a perspective view of a graph depicting a 3D constellation of the two etalons, and the linear transmission filter of the rear facet locker assembly depicted in FIG. 3;

FIG. 10 is a graph depicting example transmission curves for various linear transmission filters for use in an embodiment constructed according to the invention;

FIG. 11 is a perspective view of a graph depicting a 3D constellation of two etalons and a linear transmission filter (having a parabolic response) of the rear facet locker assembly depicted in FIG. 3;

FIG. 12 is a graph of photocurrents versus frequency of the etalon photodetectors, the LTF photodetector, and the reference photodetector of the external locker module depicted in FIG. 5;

FIG. 13 is a graph of photocurrents versus frequency of the etalon photodetectors, and the LTF photodetector, normalized with respect to the photocurrent of the reference photodetector of the external locker module depicted in FIG. 5;

FIG. 14 is a graph of photocurrent versus frequency of the LTF photodetector, normalized with respect to the photocurrent of the reference photodetector of the external locker module depicted in FIG. 5;

FIG. 15 is a perspective view of a graph depicting the constellation of the external locker module depicted in FIG. 5 from a measurement subspace 3D view defined by the first and second etalons, and the linear transmission filter;

FIG 16 is a side view of a graph depicting the constellation of the external locker module depicted in FIG. 5 from a measurement subspace 3D view defined by the first and second etalons, and the linear transmission filter;

FIG. 17 is a perspective view of a graph depicting the constellation of the external locker module depicted in FIG. 5 from a measurement subspace 3D view defined by the first etalon, the third etalon, and the linear transmission filter;

FIG. 18 is a :side view of a graph depicting the constellation of the external locker module depicted in FIG. 5 from a measurement subspace 3D view defined by the first etalon, the third etalon, and the linear transmission filter;

FIG. 19 is a perspective view of a graph depicting the constellation of the external locker module depicted in FIG. 5 from a measurement subspace 3D view defined by the first, second, and third etalon;

FIG. 20 is graph depicting the distribution of measurement errors by the external locker module about a randomized wavelength target for random power levels; and

FIG. 21 is a sample graph of wavelength error by the external locker module for 100 random frequencies and optical powers.

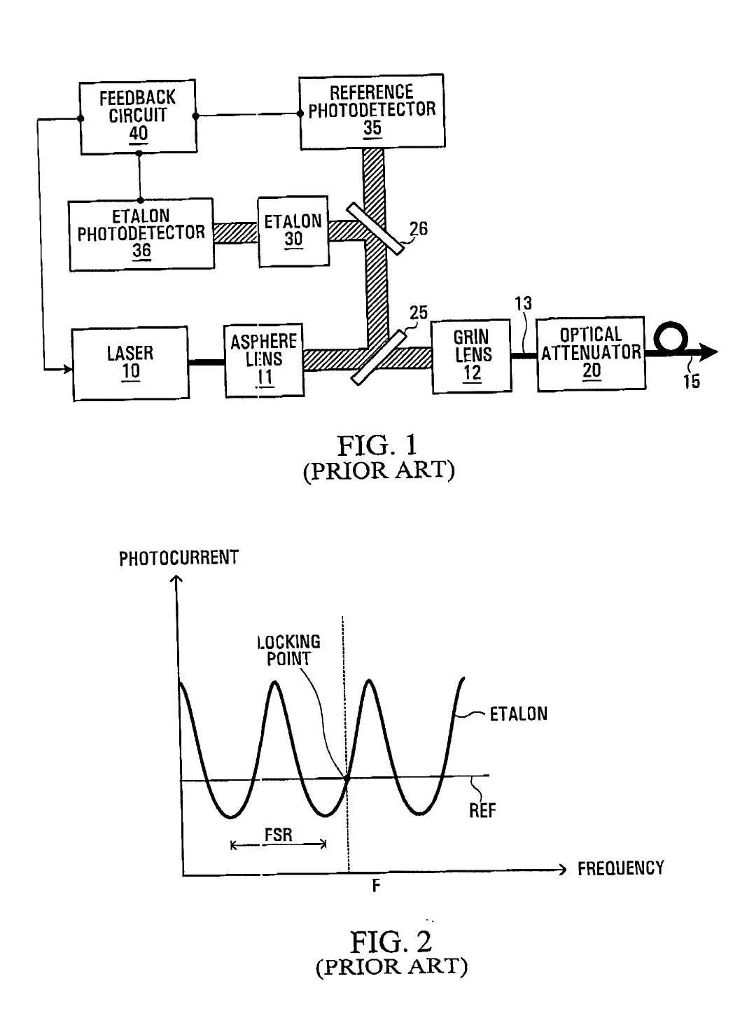

### DETAILED DESCRIPTION OF THE PREFERRED EMBODIMENTS

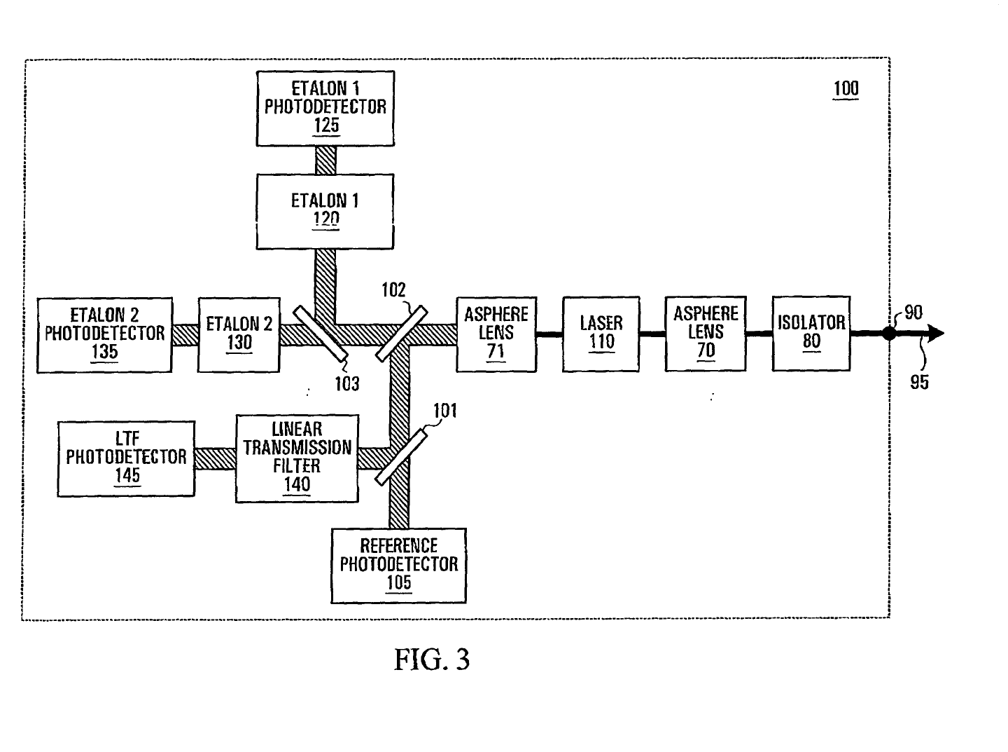

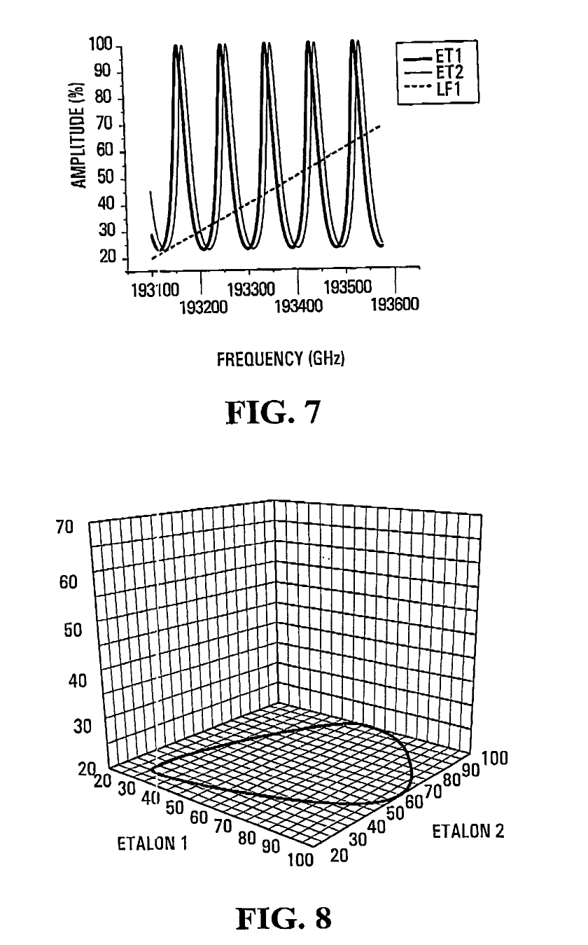

Referring to FIG. 3 a rear facet locker assembly 100 constructed according to the invention is described. The rear facet locker assembly 100 is an assembly for measuring the frequency of and locking a laser 110 incorporated therein. The laser 110, which could be a DFB, a DBR or a tunable laser, emits a forward optical signal from its front facet for use in a telecommunications system. A first asphere lens 70 is arranged to collimate the forward signal and output the forward signal to an optical isolator 80. It should be understood that the asphere lenses of this and the remaining embodiments of the invention could also be ball lenses or any other lenses of a type appropriate for collimating the optical signals. An output 90 is arranged so that the forward signal propagates from the optical isolator 80 to the output 90 of the rear facet locker assembly 100. The output 90 is coupled to a fiber span 95 which leads to the telecommunications system. From the rear facet of the laser 110 emerges a rearward optical signal for use in frequency identification and laser locking. A second asphere lens 71 is arranged to collimate the rearward signal and output the rearward signal to a first beam splitter 102. The beam splitters of this and all of the remaining embodiments could be plate or cube team splitters or any other appropriate type of beam splitter for splitting optical beams. The splitting ratio of all of the beam splitters is chosen to ensure optical signal power arriving at each of the photodetectors is large enough to be measured, and large enough so that the inherent measurement error and/or noise of each photodetector is insignificant in comparison to its measurement of signal power. A second beam splitter 101 is arranged to occupy the path of the signal reflected from the first beam splitter 102. A reference photodetector 105 is arranged to occupy the path of a signal transmitted by the second beam splitter 101. The photodetectors of this and all of the remaining embodiments may be low frequency PIN (Positive Intrinsic Negative junction diode) photodetectors or any other appropriate type of optical detector generating an output in response to intensity of incident light. A linear transmission filter (LTF) 140 is arranged to occupy the path of a signal reflected from the second beam splitter 101. The LTF 140 may have a relatively linear transmission curve having either a positive or a negative slope. It is not essential that the LTF transmission curve be perfectly linear. In general the LTF 140 may be any slope filter having a transmission curve which is linear, parabolic, or any other curve of any functional form as long as it is generally continuous and monotonic. Some examples of slope filter transmission curves are shown in FIG. 10. The example curve LF1 is linear with a positive slope. The example cure LF2 is linear with a negative slope. The example curve LF3 proportional to frequency raised to a power greater than one. The example curve LF4 is proportional to frequency raised to a power greater than one with a negative slope. All of these curves simply illustrate that the LTFs contemplated by this embodiment and the remaining embodiments need not have perfectly linear transmission curves. It should be emphasized as equally appropriate as LFT filters without a linear transmission curve are any slope filters having a generally continuous and monotonic transmission curve over the frequencies of interest. An LTF photodetector 145 is arranged to occupy the path of the signal transmitted by the linear transmission filter 140. A third beam splitter 103 is arranged to occupy the path of the signal transmitted by the first beam splitter 102. A first etalon 120 is arranged to occupy the path of the signal reflected from the third beam splitter 103. The first etalon of the preferred embodiment is a multi-wavelength glass etalon filter having an FSR of 100 GHz and a finesse of about 2.0. A first etalon photodetector 125 is arranged to occupy the path of the signal transmitted by the first etalon 120. A second etalon 130 is arranged to occupy the path of the signal transmitted by the third beam splitter 103. The second etalon of the preferred embodiment is a multi-wavelength glass etalon filter having an FSR of 100 GHz and a finesse of about 2.0 which has a transmission curve shifted in comparison with that of the first etalon by a measurable amount. This shift could be anywhere from about ±10 to ±50% of the FSR which in this case is about ±10 GHz to ±50 GHz. In FIG. 7 the transmission curves for the etalons 120 and 130, and the LTF 140 labeled ET1, ET2 and LF1 respectively are shown. In this particular instance, the relative shift between the curves ET1, and ET2 is approximately 15% or 15 GHz. A second etalon photodetector 135 is arranged to occupy the path of the signal transmitted by the second etalon 130.

It should be noted that the labeling of the photodetectors merely identifies the purpose to which they are put and does not reflect any specific differences in their operation. In the preferred embodiment depicted in FIG. 3, photodetectors 120, 130, and 140 are similar components.

It is to be understood that the etalon filters of this and the remaining embodiments may be any filter having a periodic transmission versus frequency curve similar to those shown in FIG. 2 and FIG. 7. Below is a more detailed discussion of the more general behavior and requirements for a set of filters appropriate in an assembly built according to the invention.

Not shown in FIG. 3 are a thermo-electric cooler (TEC), and a thermistor mounted on the assembly. These are provided for monitoring and regulating the temperature of the assembly and all of the components glued, epoxied, soldered or laser welded thereon in order to maintain a constant temperature to minimize transmission curve drift of the various filters as discussed above.

Referring again to FIG. 3, a rear facet locker assembly 100 constructed according to the invention is described in terms of its function. While the laser 110 is powered up, the forwards optical signal emerging from the front facet of the laser 110 for use in the telecommunications system passes through the collimating first asphere lens 70 and the isolator 80 before being output from output 90 to fiber span 95. The rearward optical signal emerging from the rear facet of the laser 110 for use in frequency identification and laser locking passes through the collimating second asphere lens 71 becoming a collimated rearward optical signal. Part of the collimated rearward optical signal is reflected from the first beam splitter 102, and transmitted through the second beam splitter 101 to be measured by the reference photodetector 105. The photocurrent output from the reference photodetector 105 is output to a computer or processor (not shown) for use in determining the frequency of and locking the laser. As is described in more detail below, the choice of filters used in the embodiment is such that for any given frequency, only one corresponding set of measurements from the photodetectors exist. Since the output from the reference photodetector 105 has not passed through any LTF or etalon filter, it serves also to monitor the power of the laser, and is used to normalize the output from the other photodetectors (described in more detail below). Part of the collimated rearward optical signal is reflected from the first beam splitter 102, reflected from the second beam splitter 101, and transmitted by the linear transmission filter 140 to be measured by the LTF photodetector 145. Part of the collimated rearward optical signal is transmitted by the first beam splitter 102, reflected from the third beam splitter 103, and transmitted by the first etalon 120 to be measured by the first etalon photodetector 125. Part of the collimated rearward optical signal is transmitted by the first beam splitter 102, transmitted by the third beam splitter 103, and transmitted by the second etalon 130 to be measured by the second etalon photodetector 135.

Each of the photodetectors 125, 135, and 145 outputs a photocurrent, based on the power of light it measures, to the computer or processor (not shown) for use in determining the frequency of and locking the laser. As with standard laser locking and frequency identification, before locking can occur a reliable identification of the frequency of the laser must be obtained. The process of frequency identification according to this embodiment of the invention initially involves a short low-power burst of light from the laser, on the order of 1 ms. As long as the duration of the low-power burst is shorter than a certain threshold time required for any signal to contaminate the telecommunications system (which in this case is 50 ms), the duration is insignificant to the operation of the telecommunications system and it does not matter if the laser is transmitting at an occupied channel frequency. It is to be understood that this burst duration is chosen to be smaller than the threshold time for the particular telecommunications system in which the laser is used. The short low-power burst is measured at the various photodetectors, and the frequency of the laser is determined from the various photocurrents output from the photodetectors (described in more detail below). Central to identifying a frequency based on a single burst measurement or photocurrents, is that there be no degeneracy in possible frequencies for that set of photocurrents measured. As was discussed above, in standard laser locking the transmission curves of the various filters used for locking have a periodicity or degeneracy, that is, for any set of measurements there are multiple possible frequencies which could give rise to them. This will specifically be discussed in more detail below. It should be noted that although it is advantageous to use thee approach as described above to avoid both the use of an external wavemeter or OSA and an optical attenuator, in an alternate approach in which some optical attenuation is provided and the power of the laser set low enough, the laser may be powered up for longer than the duration of a short burst. In fact, the laser may be left switched to its powered-up state during the entire laser locking procedure. The amount of attenuation required for this alternate approach will depend on the system configuration. As with the preferred approach, this approach does not require the use of an external wavemeter or an OSA.

With a measurement of what frequency the laser is outputting at, without the need for an optical attenuator or switch to protect the telecommunications system, the laser is then tuned (in its off state) or otherwise set up so that when it is next powered up it will hopefully be within locking acquisition range. As With current approaches, the laser is tuned in its off state based on the expected frequency behavior of the laser in accordance with measurements made shortly after production time, by appropriate changes to temperature, current and/or voltage. The process of using a short low-power burst is used again to ensure that the signal is indeed within locking range. Once it is determined to be within locking range, further tuning of the laser within the locking range entails no risk that the laser will emit light at the same frequency as a neighboring channel already used in the telecommunications system. At this point the laser can be switched on and tuned until locking is achieved.

One of the main features of this and the remaining embodiments is that for any set of measurements of photocurrent from the various photodetectors in the assembly, there corresponds only one frequency which could give rise to them. This nondegeneracy gives rise to the ability to measure an unambiguous frequency with a single measurement of all the photocurrents of the assembly. To match a set of measurements with the corresponding frequency giving rise to them, the use of a known set of normalized photocurrent values hereinafter referred to as a normalized measurement look-up table or “constellation” and their correspondence to measured frequencies is used. The nature of the constellation itself and its creation are discussed in more detail below. It should be noted that for an optical signal of a given frequency, the ratio of power of the light incident upon each of the photodetectors 125, 135, and 145 to that incident upon the reference photodetector 105 is a constant independent of the optical power of the signal emitted from the laser 110. This may be used to remove any potential common errors involved in measuring photocurrent from the various photodiodes caused for example by fluctuations in the power of the laser 110, or frequency dependence in the power of signals generated by the laser 110. Each of the outputs of the photodetectors 125, 135, and 145 behind a filter is normalized by the output of the reference photodetector 105 by respective division of the outputs of the photodetectors 125, 135, and 145 by the output of the reference photodetector 105. The normalized measurements of photocurrents from 125, 135, and 145 collectively form a normalized measurement in the measurement space (which here is a three dimensional measurement space). In general the measurement space has a dimension equal to the number of filters used. The resulting point in the measurement space is compared to the points in the normalized measurement constellation. The comparison in the preferred embodiment of the invention involves a computer or processor which has access to a data table containing the constellation for the module and includes finding the smallest Euclidean distance between all of the points in the constellation and the particular normalized measurement. The frequency of the output of the laser is determined by the point which has this smallest distance since each point in the constellation corresponds to a single frequency.

The intensity of the light transmitted by the filters themselves together define a multidimensional transmission curve parameterized by frequency. It should be understood that the constellation referred to above is a data representation of the behavior of the apparatus, and is an approximation of a normalization of photocurrents resulting from measurement of an actual multidimensional transmission curve of the specific set of filters. As such it should be kept in mind that the lockers of all of the embodiments described herein have an actual multidimensional transmission curve which does not suffer any degeneracy. The use of the constellation is a preferred way of storing a representation of a measurement of the actual multidimensional transmission curve, and determining a frequency of a laser from the output of the locker's photodetectors by using it as a look-up table advantageously using Euclidean smallest distance selection.

Since the frequency can be accurately identified, it is relatively easy to ensure that the frequency of the laser 110 is within locking acquisition range. According to standard laser locking methods, one of the etalon photodetectors 125, or 135 could be used with the reference photodetector 105, using a locking ratio to lock the laser 110. Not shown in the diagram is a feedback circuit used to tune the laser 110 in response to output from the various photodetectors 105, 125, 135, and 145. Given the choice of photodetectors, and the multitude of constellation points and associated measurements, it is contemplated that various methods other than using a locking ratio between one etalon photodetector (for example 120 or 130) and the reference photodetector 105 could be used to actually lock the laser 110.

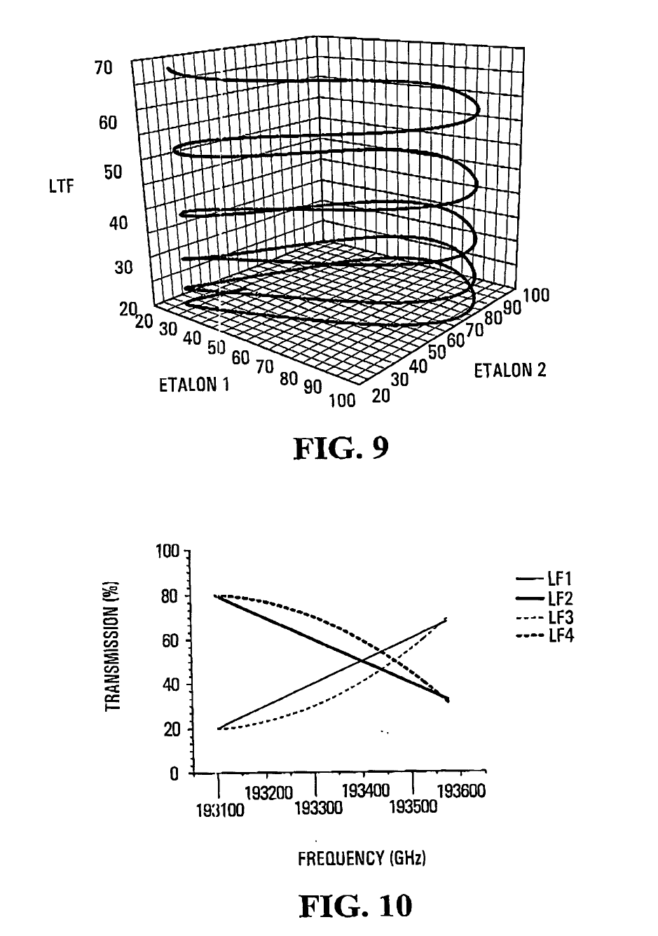

The normalized measurement constellation is created after production of the assembly during a calibration stage. A more detailed discussion outlining the calibration of the assembly and creation of the constellation in association with an external locker module is found below. An example procedure for calibrating the embodiment depicted in FIG. 3 and creating its associated constellation is to tune the laser 110 over the range of all of its possible frequencies. This reveals the actual multidimensional transmission curve of the filters of the rear facet locker assembly 100 for measurement of photocurrent samples thereof within a useful range of frequencies. To measure a sample, the output on fiber span 95 is measured by a wavemeter (not shown) which accurately identifies the frequency of the laser 110. Each of the outputs of the photodetectors is then sent to a computer, normalized, and stored in a data table along with the associated frequency measured by the wavemeter. The set of photocurrents together define a point of the measurement constellation and is associated in the data table with the frequency measured by the wavemeter. The desired frequency resolution for the constellation will dictate the density of points per unit frequency, which may be varied depending upon a number considerations. Such considerations are the storage capacity required to store all of the points of the constellation, and the resulting processing required to use the constellation to find the correct frequency. As the storage and processing capability of the associated computer system or processor increases, so does this density of points which can be dealt with. Once the laser has swept through all of its possible frequencies, and all the desired points measured, the constellation is complete. In standard laser lockers one or possibly more etalon filters are used for laser locking. FIG. 8 shows a plot of the measurement constellation of the locker of FIG. 3, in the measurement subspace defined by the two etalons. Since the transmission curves of the etalons are out of phase, but have the same FSR, the constellation forms a closed series of loops. Due to the fact that these loops overlap, no discrimination beyond a single cycle can be made. This is the problem with standard methods of laser locking and frequency identification, which requires the use of a wavemeter or OSA along with an optical attenuator or switch until the laser is within the proper locking acquisition range. In the preferred and remaining embodiments, an additional filter having a continuous and monotonic transmission curve is employed. Preferably the additional filter is a linear transmission filter as shown in the preferred embodiments. FIG. 9 illustrates the constellation for the rear facet locker assembly of FIG. 3. The three dimensional graph of the constellation exhibits the periodic looping in the etalon subspace, along with the linear progression in the linear transmission measurement dimension (LTF). This results in a constellation having a helical structure which is continuous and nondegenerate. That is as frequency is varied, the constellation never doubles back on itself, ensuring that for any one constellation point in measurement space, there is only one corresponding frequency. As an alternative to the above approach of storing the normalized measured points in a data table forming the constellation, the set of measured points may be evaluated to generate parameters for curve fitting a set of equations. The parameters of the equations which fit the measured points could then be stored instead of the points themselves. In this sense the constellation is stored only in a parameterized form. When the constellation points are required for the measurement of a laser's frequency, the computer system or processor would use the same equations with the stored parameters to recreate data points of the measurement constellation for use in a comparison (for example the Euclidean smallest distance comparison as described below). This approach of storing parameters of fit curves rather than the points of the constellation itself will generally require less memory, however the generation of each point of the constellation from the use of the equations will require more computing power.

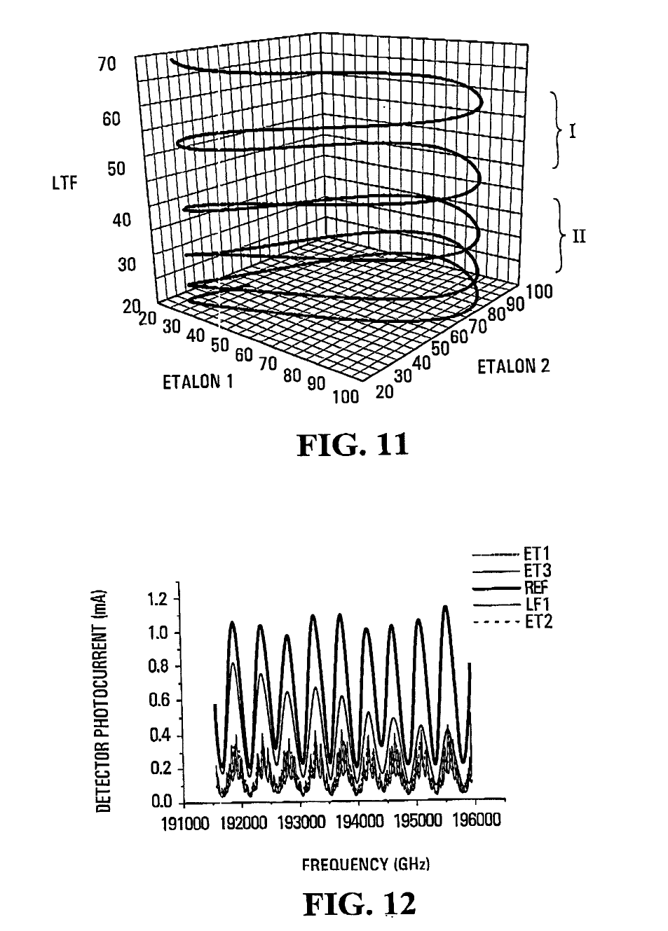

As was discussed above FIG. 10 depicts a number of possible example continuous monotonic curves which the linear transmission filter or its substitutable equivalent could have. FIG. 11 shows a constellation for the assembly of FIG. 3, using an LTF which has a parabolic response versus frequency such as that which would produce the curve LF3 in FIG. 10. In FIG. 11, it can be seen that the parabolic nature of the curve for the LTF causes different ring spacing in the measurement space. In region I there is a comparatively larger space between rings than in region II.

As long as the spacing between rings is not smaller than the inherent error in the measurement or noise in the system, any actual point measured can be compared with the constellation to determine which point in the constellation is closest using a Euclidean distance comparison to obtain an accurate frequency measurement.

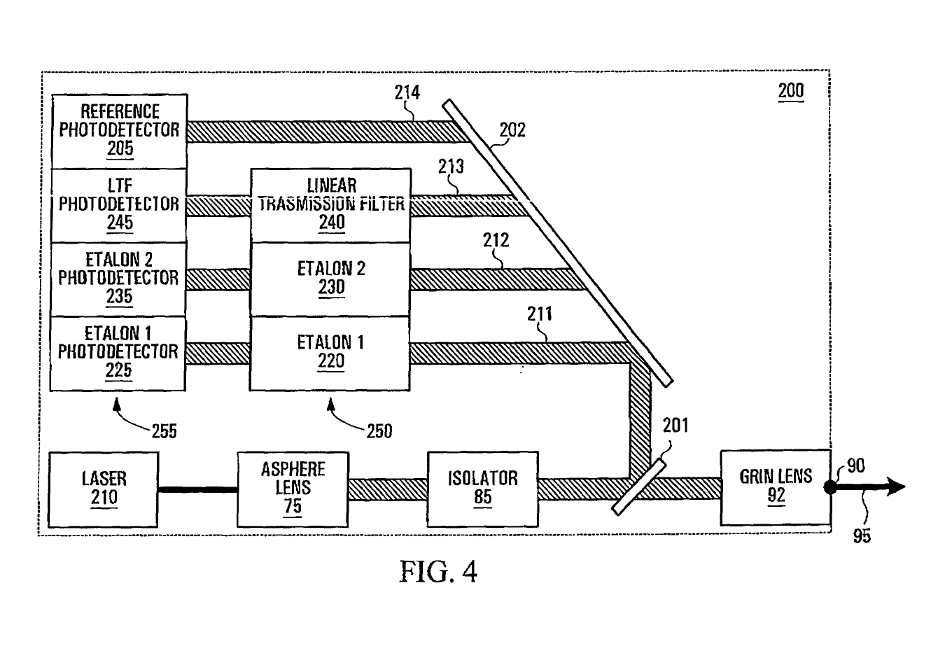

Referring now to FIG. 4, a compact front locker assembly 200 constructed according to the invention is described. The compact front locker assembly 200 is an assembly for measuring the frequency of and locking a laser 210 incorporated therein. The laser 210, which could be a DFB, DBR, TGC, or MEMS VCSEL (vertical cavity surface emitting laser tunable laser) emits a forward optical signal for use in a telecommunications system. A first asphere lens 75 is arranged to collimate the forward signal and output the forward signal to an isolator 85. A beam splitter 201 is arranged to occupy the path of the signals transmitted from the isolator 85. The splitting ratio of the beam splitter 201 which actually acts as a tap, is approximately 2%-10% reflection to 90%-98% transmission. A GRIN lens 92 is arranged to occupy the path of signals transmitted by the beam splitter 201. The GRIN lens 92 outputs the signal at an output 90 of the front locker assembly 100. The output 90 is coupled to a fiber span 95 which leads to the telecommunications system. A walk-off reflector 202 is arranged to occupy the path of signals reflected from the beam splitter 201. The walk-off reflector reflects a first order reflected signal 211, a second order reflected signal 212, a third order reflected signal 213, and a fourth order reflected signal 214. Not shown in the figure is an absorber to absorb any higher order reflected signals in the walk-off reflector 202. A filter bar generally indicated by 250 is arranged to occupy the path or the first 211, second 212, and third 213 order reflected signals. The filter bar 250 has a first etalon filter 220 arranged to occupy the path of the first order reflected signal 211, a second etalon filter 230 arranged to occupy the path of the second order reflected signal 212, and a linear transmission filter 240 arranged to occupy the path of the third order reflected signal 213. The first etalon filter 220 is a multi-wavelength glass etalon filter having an FSR of 100 GHz and a finesse of 2.0. The second etalon filter 230 is a multi-wavelength glass etalon filter having an FSR of approximately 100 GHz and a finesse of 2.0, and has a transmission curve which is shifted from that of the first etalon. This shift could be anywhere from about ±10% to ±50% of the FSR which in this case is about ±10 GHz to ±50 GHz. As with the embodiment discussed in association with FIG. 3, the linear transmission filter 240 may have a relatively linear transmission curve having either a positive or a negative slope. The filter bar 250 may be a single component with regions 220, 230, and 240 having different optical properties or a composite of individual filters as shown in the diagram. A detector bar generally indicated by 255 is arranged to occupy the path of signals transmitted by the first etalon filter 220, the second etalon filter 230, and the linear transmission filter 240, and the fourth order reflected signals 214 reflected from the walk off reflector 202. The detector bar 255 has a first etalon detector 225 arranged to occupy the path of the signal transmitted by the first etalon filter 220, a second etalon photodetector 235 arranged to occupy the path of the signal transmitted by the second etalon filter 230, an LTF photodetector 245 arranged to occupy the path of the signal transmitted by the linear transmission filter 240, and a reference photodetector 205 arranged to occupy the path of the fourth order reflected signal 214. The reflected signal power ratios of the walk-off reflector 202 are chosen to ensure optical signal power arriving at each of the photodetectors is large enough to be measured, and large enough so that the inherent measurement error and/or noise of the photodetector is insignificant in comparison to its measurement of signal power. In the preferred embodiment depicted in FIG. 4, the front surface of the walk-oaf reflector is 38% reflective while the back surface is 100% reflective.

Not shown in, FIG. 4 are a thermoelectric cooler (TEC), and a thermistor mounted on the assembly. As discussed above with respect to previously mentioned embodiments, these are provided for monitoring and regulating the temperature of the assembly and all of the components glued thereon in order to maintain a constant temperature to minimize transmission curve drift of the various filters.

Referring to FIG. 4, a compact front locker assembly 200 constructed according to the invention is described in terms of its function. While the laser 210 is powered up, the optical signal emerging from the laser 210 passes through the collimating first asphere lens 75 and the isolator 80 before encountering the first beam splitter 201. The transmitted signal from the first beam splitter 201 passes through a GRIN lens 92 and is output from output 90 to fiber span 95. The optical signal reflected from the first beam splitter 201 for use in frequency identification and laser locking encounters the walk-off reflector 202. The walk-off reflector 202 partially reflects the optical signal reflected from the first beam splitter 201 as a first order reflected signal 211. A portion of the optical signal reflected from the first beam splitter 201 is transmitted into the interior of the walk-off reflector (not shown) in which the signal undergoes successive internal reflections generating successive second, third and fourth order reflected signals 212, 213, and 214 respectively. The fourth order reflected signal 214 is measured by the reference photodetector 205. The photocurrent output from the reference photodetector 205 is output to a computer or processor (not shown) for use in determining the frequency of and locking the laser. Since, the output from the reference photodetector 205 has not passed through any LTF or etalon filter, it serves also to monitor the power of the laser, and is used to normalize the output from the other photodetectors. The third order reflected signal 213 is transmitted by the linear transmission filter 240 to be measured by the LTF photodetector 245. The second order reflected signal 212 is transmitted by the second etalon 230 to be measured by the second etalon photodetector 235. The first order reflected signal 211 is transmitted by the first etalon 220 to be measured by the first etalon photodetector 225.

Each of the photodetectors 225, 235, and 245 outputs a photocurrent, based on the power of light it measures, to the computer or processor (not shown) which has access to the data 120 table containing the constellation of the assembly 200.

It should be noted that an alternate embodiment to that depicted in FIG. 4 may be arranged as a compact rear locker assembly. In a compact rear locker assembly arrangement, a collimated reward optical signal from the back facet of a laser is provided to the walk-off reflector. The forward optical signal in this alternate embodiment would pass through a GRIN lens, through the output of the assembly, and onto an output fiber to the telecommunications system.

Although this embodiment differs from the rear facet locker assembly depicted in FIG. 3, the principles upon which the compact front locker assembly works is the same. A sample of the laser 210 low-power burst signal of about 1 ms is obtained by use of the first beam splitter 201. Photocurrents from a reference photodetector 20S, an LTF photodetector 245 and two etalon photodetectors 225, 235 are obtained. With the use of the constellation for the apparatus, a frequency identification is made, and the laser 210 is adjusted to transmit within the locking acquisition range. After the laser's frequency is confirmed to be within the locking acquisition range by way of a second short low-power optical burst, the laser 210 is safely powered up for locking according to standard locking principles. As was described in association with the rear facet locker assembly depicted in FIG. 3, if some optical attenuation is provided and the power of the laser set low enough, the laser may be powered up for longer than the duration of a short burst.

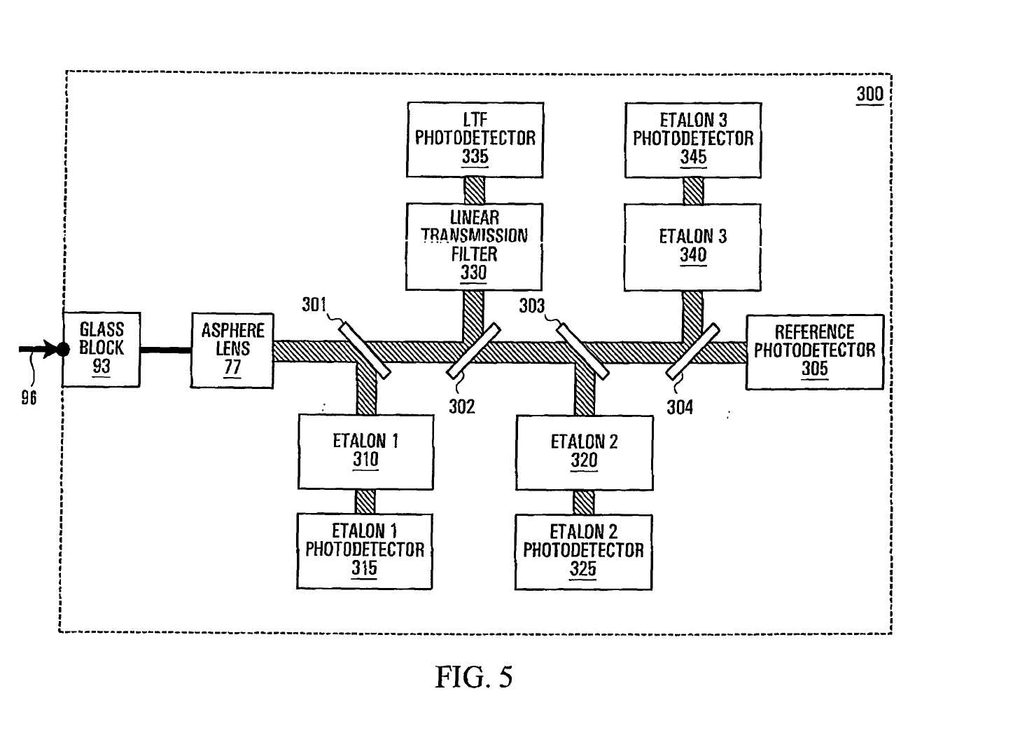

Referring to FIG. 5, an external locker module 300 constructed according to the invention is described. An external locker module 300 is external in that it does not include a laser. The external locker module 300 therefore can be used as a stand alone wavemeter/frequency identification apparatus, or as part of a laser locking system. Input optical fiber 96 is held in a glass block 93. The glass block 93 is optically connected by a waveguide portion to an asphere lens 77. It should be noted that the glass block 93 together with the asphere lens 77 in general can be replaced with a single GRIN lens. A first beam splitter 301 is arranged to occupy the path of an optical signal emerging from the asphere lens 77. A first etalon filter 310 is arranged to occupy the path of signals reflected from the first beam splitter 301. The first etalon filter 310 is a multi-wavelength glass etalon filter having an FSR of 100 GHz and a finesse of 2.0. A first etalon photodetector 315 is arranged to occupy the path of signals transmitted by the first etalon filter 310. A second beam splitter 302 is arranged to occupy the path of signals transmitted by the first beam splitter 301. A linear transmission filter 330 is arranged to occupy the path of signals reflected from the second beam splitter 302. An LTF photodetector 335 is arranged to occupy the path of signals transmitted by the linear transmission filter 330. A third beam splitter 303 is arranged to occupy the path of an optical signal transmitted by the second beam splitter 302. A second etalon filter 320 is arranged to occupy the path of signals reflected from the third beam splitter 303. The second etalon filter 320 is a multi-wavelength glass etalon filter having an FSR of 100 GHz and a finesse of 2.0. A second etalon photodetector 325 is arranged to occupy the path of signals transmitted by the second etalon filter 320. A fourth beam splitter 304 is arranged to occupy the path of an optical signal transmitted by the third beam splitter 303. A third etalon filter 340 is arranged to occupy the path of signals reflected from the fourth beam splitter 304. The third etalon filter 340 is a multi-wavelength glass etalon filter having an FSR of 110 GHz and a finesse of 2.0. A third etalon photodetector 345 is arranged to occupy the path of signals transmitted by the third etalon filter 340. A reference photodetector 305 is arranged to occupy the path of signals transmitted by the fourth beam splitter 304. Not shown are outputs of the photodetectors 305, 315, 325, 335, and 345, which are connected to a computer (also not shown) or processing device which has access to a data table containing the constellation for the module.

Not shown in FIG. 5 are a thermo-electric cooler (TEC), and a thermistor mounted on the assembly. As discussed above with respect to previously mentioned embodiments, these are provided for monitoring and regulating the temperature of the assembly and all of the components glued thereon in order to maintain a constant temperature to minimize transmission curve drift of the various filters.

Although not shown in FIG. 5, if the beam splitters or the optical filters are polarization sensitive, an optical polarizer plate can be introduced between the asphere lens 77 and the first beam splitter 301 to compensate for said polarization dependency.

Referring to FIG. 5, an external locker module 300 constructed according co the invention is described in terms of its function. While tile external laser (not shown) is powered up, the optical signal emerging from the laser enters the module 300 from input fiber 96 through the glass block 93 and is collimated by the asphere lens 77. The optical signal output from the asphere lens 77 encounters the first beam splitter 301. Part of the optical signal output is transmitted through the first beam splitter 301, the second beam splitter 302, the third beam splitter 303, and the fourth beam splitter 304, to be measured by he reference photodetector 305. The photocurrent output from the reference photodetector 305 is output to a computer or processor (not shown) for use in determining the frequency of and locking the laser. Since the output from the reference photodetector 305 has not passed through any LTF or etalon filter, it serves also to monitor the power of the laser, and is used to normalize the output from the other photodetectors as described above. Part of the optical signal is reflected from the first beam splitter 301, and transmitted by the first etalon filter 310 to be measured by the first etalon photodetector 315. Part of the optical signal is transmitted through the first beam splitter 301, reflected from the second beam splitter 302, and transmitted by the linear transmission filter 330 to be measured by the LTF photodetector 335. Part of the optical signal is transmitted by the first beam splitter 301, transmitted by the second beam splitter 302, and reflected by the third beam splitter 303, and transmitted by the second etalon 320 to be measured by the second etalon photodetector 325. Part of the optical signal is transmitted by the first beam splitter 301, transmitted by the second beam splitter 302, transmitted by the third beam splitter 303, reflected by the fourth beam splitter 304, and transmitted by the third etalon 340 to be measured by the third etalon photodetector 345.

Each of the photodetectors 315, 325, 335, and 345 outputs a photocurrent, based on the power of light it measures, to the computer or processor (not shown) which has access to the data table containing the constellation of the module 300.

Although this embodiment differs from the previous ones, the principles upon which the external locker module 300 works is generally the same. In this case since the laser is not internal to the module, the module may also be used as a stand alone wavemeter/frequency identifier. Whether or not it is used in association with locking, the frequency of the laser input over input fiber 96 is measured by obtaining the photocurrents of the etalon photodetectors 315, 325, and the LTF photodetectors 335, 345, and using the constellation for the apparatus. By comparing the measurement of photocurrents with the points in the constellation using a smallest Euclidean distance, a frequency measurement is made. As was described in association with the embodiment depicted in FIG. 3, instead of a the constellation toeing stored as a at of points, it may be stored in parameterized form, and used to generate constellation points for a comparison with measured photocurrents.

As a wavemeter/frequency identifier, the module as the advantage of having an instantaneous output of photocurrents limited only by the optical properties of the filters and the photodetectors, and in the context of use with an associated computer or processor, limited only by the storage capacity and processing power of the associated computer or processor. The external locker module for example is ideal for measuring a laser at production time. A computer or processor would simply read the outputs as the laser is swept across its various temperature, current and or voltage settings. By using the constellation to identify frequencies, the laser's calibration table is easily generated.

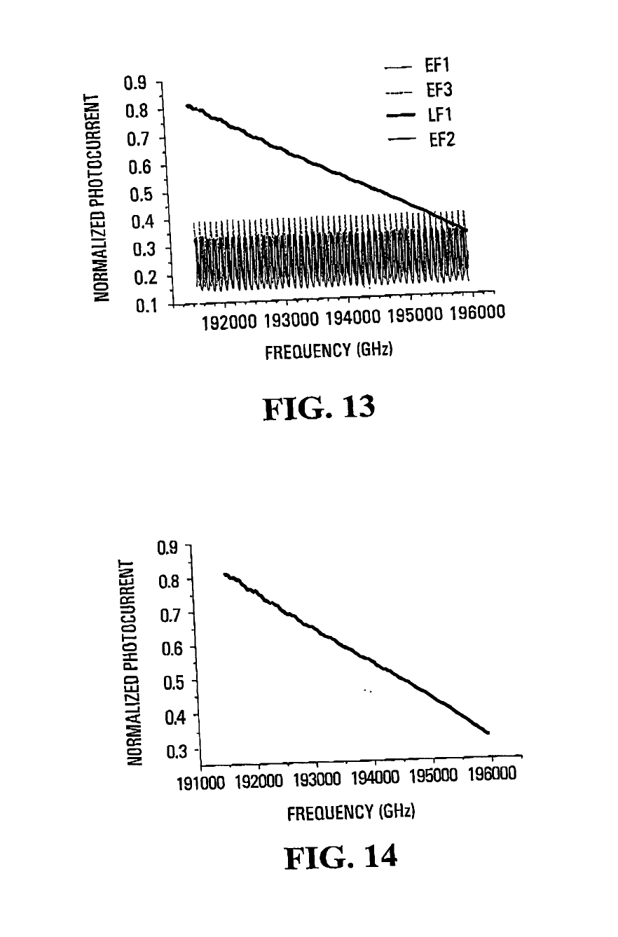

In FIG. 12, photocurrents of the etalon photodetectors, the LTF photodetector, and the reference photodetector of the external locker module 300 are shown. The photocurrent of the first etalon photodetector 315 is labeled ET1. The photocurrent of the second etalon photodetector 325 is labeled ET2. The photocurrent of the third etalon photodetector 345 is labeled ET3. The photocurrent of the linear transmission photodetector 335 is labeled LF1. The photocurrent of the reference photodetector 305 is labeled REF. As can be seen in the graph, the photocurrent of the reference photodetector 305 REF varies with the frequency of the laser showing the power generating variation (residual cavities) in the laser itself. This change in optical power as a function of frequency is reflected in the photocurrents measured by all of the other photodetectors. In FIG. 13 normalized photocurrents of the etalon photodetectors, and the LTF photodetector of the external locker module 300 are shown. Each plot of normalized photocurrent versus frequency is obtained by dividing the photocurrents of the etalon photodetectors, and the LTF photodetector, by the photocurrent of the reference photodetector. As shown in FIG. 13, the frequency dependence due to the power generating variation of the laser has been removed from the transmission curves. As discussed above, it should be noted that power fluctuations over time do not affect the normalized transmission curve because of the proportionality of all of the photocurrents to the power of the laser. FIG. 14 shows the normalized transmission curve of an LTF photodetector, As can be seen in the plot, the curve is continuous and essentially linear with a negative slope.

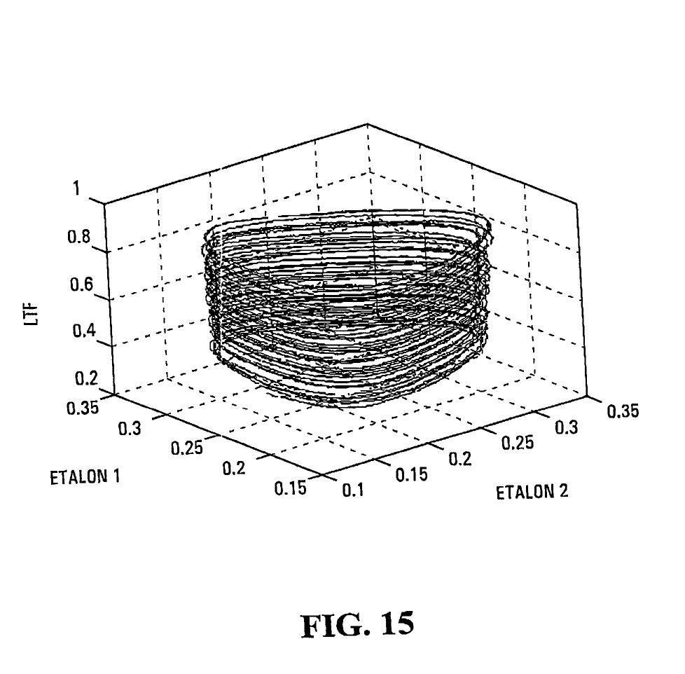

In FIG. 15 a perspective view of the constellation of the external locker module depicted in FIG. 5 from a measurement subspace 3D view defined by the two 100 GHz etalons, and the linear transmission filter of the external locker module depicted 300 is discussed. Since the locker module of FIG. 5 has a total of four filters, its associated constellation exists in a 4D measurement space. FIG. 15 depicts the three dimensional subspace defined by only three of the filters. As can be seen from the varying ring size of the constellation, there are slight variations in the etalon filter transmission curves from an ideal periodic curve. These variations however do not pose a problem if the rings are spaced greater than the inherent measurement accuracy when making a measurements of normalized photocurrents.

It should be noted that in order to visualize the constellation, different 3D subspaces of the 4D measurement space are presented in FIGS. 15, 17 and 19. In general the number of filters and hence the dimension of the measurement space of a constellation may be any whole number integer N which is greater than or equal to 1. In general as the number of filters used increases, so does the degree of accuracy of the frequency measurement. For example in order to reach 1 pm (0.125 GHz) accuracy in frequency, preferably 3 or 4 filters would be used, for example 2 or 3 etalon filters in conjunction with a linear transmission filter.

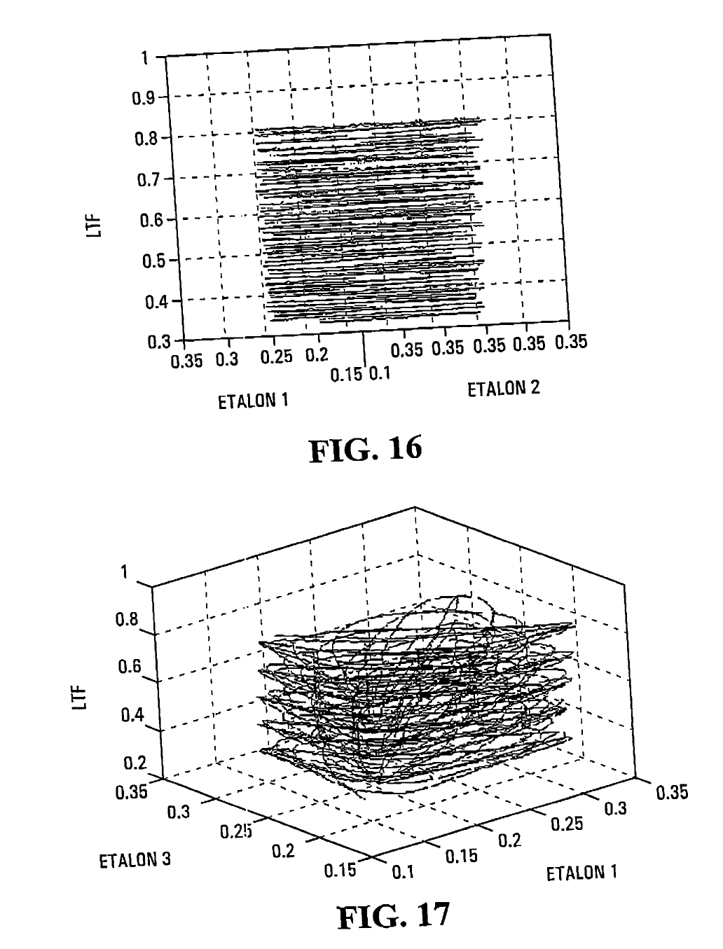

In FIG. 16, a side view of the graph of FIG. 15 shows that the variation of the linear transmission filter curve from an ideal Linear curve exhibits itself in uneven spacing of the rings of the constellation. As mentioned previously, as long as the ring spacing is larger than the inherent measurement accuracy when making a measurements of normalized photocurrents.

FIG. 17 shows a perspective view of a graph depicting the constellation of the external locker module depicted in FIG. 5 from a measurement subspace 3D view defined by the first etalon, the third etalon, and the linear transmission filter. Although not apparent from the perspective view, the constellation does not intersect itself due to the transmission curve of the linear filter.

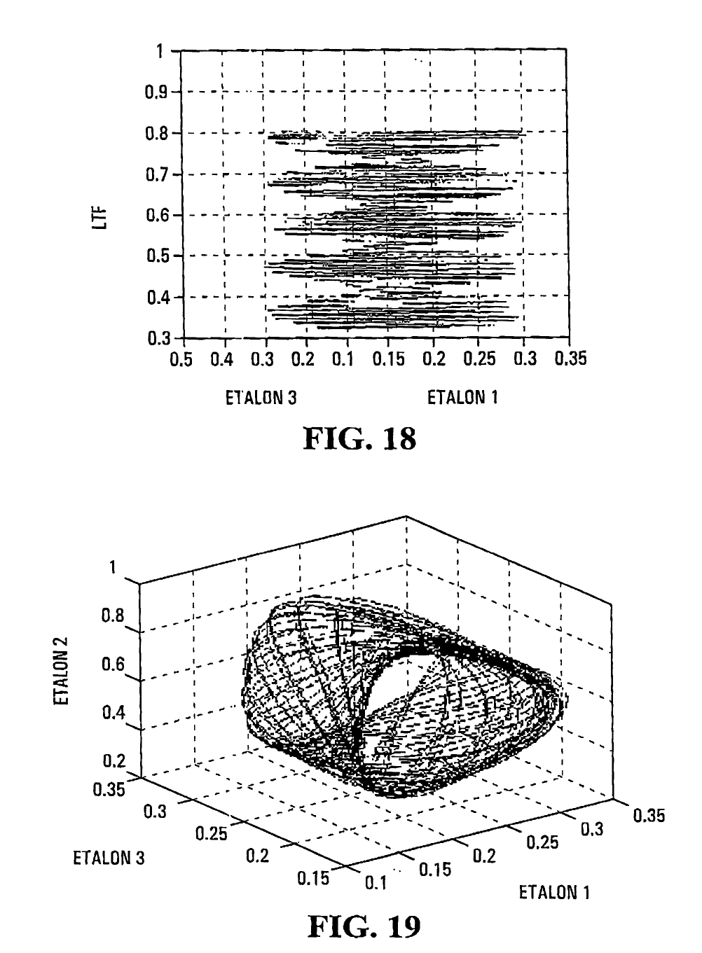

FIG. 18 .Ls a side view of the graph of FIG. 17. Since the third talon and the first etalon have different FSRs, a beat pattern arises, showing the varying relationship between their offsets.

FIG. 19 is a perspective view of a graph depicting the constellation of the external locker module depicted in FIG. 5 from a measurement subspace 3D view defined by the first, second, and third etalon. In this subspace, it can be seen that without taking into account the linear transmission filter, the constellation appears to intersect itself. In fact, a external locker module as depicted in FIG. 5 in which no linear or similar type filter is used, may have degeneracy due to the periodic stature of transmission curves of the etalon filters.

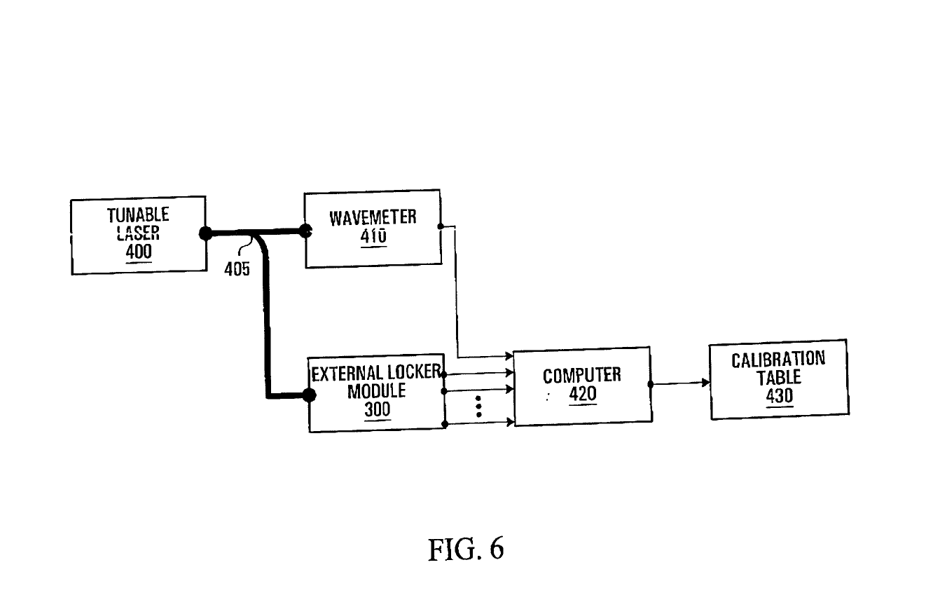

Referring now to FIG. 6, the creation of the constellation for the external locker module 300 described in association with FIG. 5 is described. It should be noted that the general method of creating the constellation is the same for every embodiment, differing only in that some cases the laser will be internal and in others external. The constellation is created by tuning a tunable laser 400 through all frequencies that make up the desired range of frequencies that the external locker module 300 should be able to measure. Part of the signal from the tunable laser 400 is input to a wavemeter 410 which makes a very accurate measurement of the frequency of the laser 400. The actual frequency measured is output to a computer 420. Part of the output of the tunable laser 400 is split at splitter 405. A portion of the signal is injected into an external locker module 300. This is to reveal the actual multidimensional transmission curve of the external locker module 300 for measurement of photocurrent samples thereof within the desired range of frequencies. The photocurrents of the photodiodes of the external locker module 300 are output to the computer 420. The computer normalizes the photocurrents by dividing each of the etalon and LTF photodetector photocurrents by the reference photodetector photocurrent, to form a point of the normalized constellation and associates the frequency output of the wavemeter 410 with the corresponding point. Both the constellation point and the associated frequency are stored in the calibration table. The calibration table may also contain for each point an index, and possibly the original photocurrents for all of the filters. In the alternate approach described above a parameterized constellation may be stored in the table. This involves the fitting of equations to the various normalized photocurrents. The samples obtained from an Etalon are curve fit with an Airy function:

$$\begin{matrix}{I}_{T} = \frac{{{I}_{0} ( 1 - R )}^{2}}{{( 1 - R )}^{2} + 4 R {sin}^{2} ( \frac{φ}{2} )} \\ φ = \frac{4 π nd \sqrt{1 - {sin}^{2} ( α )}}{λ} + Δ φ\end{matrix}$$

Here I_{T}. is the transmitted intensity, I₀, is the maximum intensity to be curve fitted, R is the known etalon mirror reflectivity, d is the known etalon thickness, n is the known etalon index of refraction, Δφ is the phase jump at reflection of the mirror (typically equal to π), λ is the wavelength, and a is the angle of the light in the etalon. All of these parameters would be stored in the data table.

The linear or slope filter can be curve fitted with a polynomial equation:

Y(ƒ)=α₀+α₁ƒ+α₂ƒ²+α₃ƒ³+. . .+αₘƒ^{m}

Here Y(ƒ) is the normalized transmitted power as a function of frequency ƒ (a linear expansion in terms of wavelength λ could equally be used in place of the curve fitted as a function of frequency ƒ). The polynomial may be expanded to any degree m, however storage for the (m+1) parameters α. . . α, would have to be provided. It is to be understood that any equation with appropriate parameters which can be curve fit to the normalized photocurrents of any of the filters.

It should be noted that since an external locker module 300 (with appropriate processor and stored constellation) which has already been calibrated may be used as a standalone wavemeter, a calibrated external locker module 300 (with appropriate processor and stored constellation) may be used in place of the wavemeter 410 to calibrate any of the lockers or frequency identification assemblies built according to the invention. This results in a very fast calibration.

As described above, to measure the frequency of an unknown laser in any of the embodiments, the photocurrents of the photodiodes receiving light transmitted through filters are normalized with respect to the reference photodetector. These normalized photocurrents make up a normalized measurement point. This normalized measurement point P is then compared with every point C in the constellation for the assembly. The comparison is a Euclidean distance measurement, and frequency associated with the point of the constellation whose distance to the normalized measurement is the shortest, is taken to be the frequency of the laser. Let there be N filters in the assembly, and hence N photodetectors, and M points in the constellation. Let the ith constellation point be denoted C(i). Since there are N normalized readings, both C(i), and P have N normalized components, each corresponding to a photodetector, and denoted as {C_{PD1}(i). . .C_{PDN}(i)}, and {P_{PD1}. . .P_{PDN}}. For each point C(i) compared to P, in the preferred embodiment, the following Euclidean distance D(i) comparison is made.

$$D ( i ) = \sqrt{{( {P}_{PD1} - {C}_{PD1} ( i ) )}^{2} + {( {P}_{PD2} - {C}_{PD2} ( i ) )}^{2} + … {( {P}_{PDN} - {C}_{PDN} ( i ) )}^{2}}$$

Once this comparison has been made with all of the points C(i) of the constellation, the point having the smallest distance D(i) is associated with a frequency in the calibration table which becomes the measurement of frequency made by the assembly. Since the actual value of the minimum distance D(i) is not of interest, and since the smallest distance D(i) corresponds to the same constellation points as the smallest distance squared D(I)¹, the square root operation shown above need not actually be carried out by a computer or processor when performing the smallest Euclidean distance comparison. The point having the smallest distance D(i)²:

D(i)²=(P_{PD1}−C_{PD1}(i))²+(P_{PD2}−C_{PD2}(i))²+. . . (P_{PDN}−C_{PDN}(i))

is associated with a frequency in the calibration table which becomes the measurement of frequency made by the assembly. In the case where the constellation is parameterized as described above, each point C(i) of the constellation must be generated from the parameterized equations before the Euclidean distance comparison is made.

Although specific approaches for the various embodiments have been described for the correlation of a normalized measurement to points of a constellation, any approach which produces a unique frequency using a comparison equivalent to or incorporating a Euclidean smallest distance comparison may be used.

Some approaches may for example use weighting, or interpolation in conjunction with a Euclidean smallest distance comparison. Other approaches may use multiple normalized measurements, averaging over time or frequency to either reduce noise or improve certainty. Some approaches if used with an appropriate constellation, may reduce the multidimensional problem into a single dimensional problem, for example by finding the distance of all of the constellation points to a fixed reference point (in measurement space), and then comparing the Euclidean distance of a normalized measured point to the fixed reference point to find the corresponding point in the constellation.

Instead of performing a Euclidean smallest distance comparison of a normalized measurement with all of the points of the constellation, the normalized measurement of the slope filter can first be used to determine a general frequency range around an initial frequency estimate. This general frequency range could then be used to select which points of the constellation to compare to the normalized measurement, namely the constellation points falling within that range of frequencies around the initial frequency estimate.

In general there are numerous approaches for comparing the normalized measurement with the data contained in the constellation incorporating at least one comparison equivalent to a Euclidean smallest distance comparison.

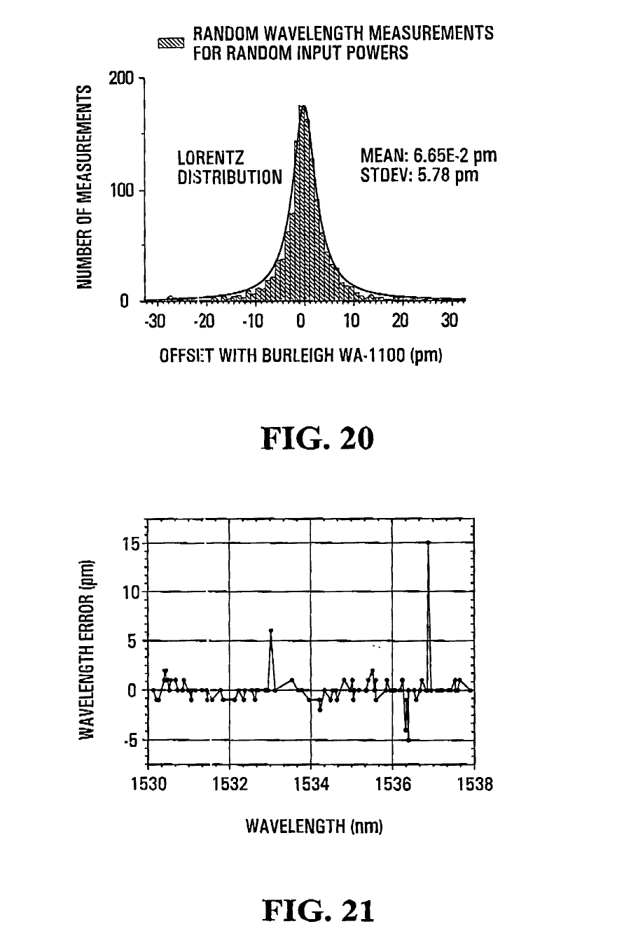

FIG. 20 shows the frequency offset measured with the external locker module depicted in FIG. 5. The mean wavelength error is 0.0665 pm (0.000 84 GHz) with a standard deviation of 0.72 GHz (5.78 pm) This graph is representative of just under 1300 measurements. For each point, the frequency and power of the tunable laser were randomly varied.

FIG. 18 shows an example graph of wavelength error sorted as a function of wavelength for 100 random measurements made with the external locker module 300. The graph shows a high quality calibration in between 1530 and 1538 nm. In this calibration, noise levels are very low. Then 100 random measurements were done with an Agilent™ tunable laser. For each point, the wavelength and optical power were chosen randomly. The wavelength was chosen in between 1530 and 1538 nm and the optical power was chosen in between 1 to 5 mW. The output of the tunable laser was split so that 10% was sent to a WA-1100 Burleigh™ wavemeter and 90% was sent to the external locker module. The average error is 0.15 pm and the standard deviation is 1.90 pm. Thus the three-sigma boundaries are 0.15±3×1.90=>−5.55 and +5.85 pm. So the accuracy of the frequency identification in between 1530 and 1538 is ±5.9 pm with a confidence of 99.7%.

It should be noted that the actual physical arrangements shown are only example preferred arrangements. The use of beam splitters oriented at 45° to optical paths is not required, only that the optical signals of the laser are somehow transmitted by appropriately arranged filters and the transmitted signals are somehow measured by appropriately arranged photodetectors.

As described above it is to be kept in mind that the actual number of filters and the type used will depend upon the desired accuracy of frequency measurement. The use of etalons or linear filters may be subject to various well known considerations. Advantageously, the type of filters, and their transmission curves are chosen to ensure non-degeneracy over a range of desired frequencies. As such in general it does not matter in fact whether or not an actual linear or etalon filter is used, and the invention contemplates a combination of filters which may have any transmission curve as long as the constellation on the whole does not intersect itself or come so near to itself at to come within a certain error threshold

The frequency identifiers and laser lockers built according to the preferred embodiments of the invention allow frequency locking better that 2 GHz and mitigates some of the start up procedure problems (in the context of decreasing channel spacing) of the prior art. It has been shown that the various embodiments of the invention provide a way to measure a laser during production which is cost efficient and faster than traditional approaches. It also has been shown that the embodiments provide a single solution for determining the frequency of and locking of any telecommunications laser (for example DFB, DBR, TGC, or MEMS tunable lasers) without having to implement an optical attenuator or switch to protect the telecommunications system, and which is accurate without the use of external wavemeters or optical spectrum analyzers and moreover does not require the laser to be swept through a wide range of frequencies.

Numerous modifications and variations of the present invention are possible in light of the above teachings. It is therefore to be understood that within the scope of the appended claims, the invention may be practised otherwise than as specifically described herein.

We claim:

1. A frequency identification apparatus for frequency identification of an optical signal having a frequency comprising:
a plurality of optical filters for producing a set of filtered optical signals from portions of said optical signal, the set of filtered optical signals having a corresponding set of filtered optical signal powers, the plurality of optical filters being such that when the frequency of the optical signal is any first frequency, the set of filtered optical signal powers together with a power of an unfiltered portion of the optical signal is different from the set of filtered optical signal powers together with the power of the unfiltered portion of the optical signal when the frequency of the optical signal is any second frequency different from said first frequency; and
an optical power measuring device for measuring the set of filtered optical signal powers and generating a corresponding set of optical power measurements, and for measuring the power of the unfiltered portion of the optical signal and generating a corresponding reference optical power measurement;
wherein the set of optical power measurements and the reference optical power measurement uniquely identify the frequency of the optical signal.

2. A frequency identification apparatus according to claim 1 wherein the plurality of optical filters comprises at least one slope filter.

3. A frequency identification apparatus according to claim 1 further comprising:
a computing device for processing said set of optical power measurements and said reference optical power measurement to generate a frequency identification of the frequency of the optical signal.

4. A frequency identification apparatus according to claim 1 wherein the optical power measuring device comprises a plurality of filter photodetectors for generating said corresponding set of optical power measurements from said set of filtered optical signals, and a reference photodetector for producing said reference optical power measurement from said unfiltered portion of the optical signal.

5. A frequency identification apparatus according to claim 1 further comprising:
a plurality of beam splitters for generating said portions of the optical signal from the optical signal and for generating said unfiltered portion of the optical signal from the optical signal, said plurality of beam splitters for providing said portions of the optical signal to said plurality of optical filters, and for providing said unfiltered portion of the optical signal to the optical power measuring device.

6. A frequency identification apparatus according to claim 4 further comprising:
a plurality of beam splitters for generating said portions of the optical signal from the optical signal and for generating said unfiltered portion of the optical signal from the optical signal, said plurality of beam splitters for providing said portions of the optical signal to said plurality of optical filters, and for providing said unfiltered portion of the optical signal to the reference photodetector.

7. A frequency identification apparatus according to claim 4 further comprising:
a walk-off reflector for generating said portions of the optical signal from the optical signal and for generating said unfiltered portion of the optical signal from the optical signal, said walk-off reflector for providing said portions of the optical signal to said plurality of optical filters, and for providing said unfiltered portion of the optical signal to the reference photodetector.

8. A frequency identification apparatus according to claim 3 further comprising:
a data table containing a constellation of the frequency identification apparatus;
wherein the computing device processes the constellation of the frequency identification apparatus to generate the frequency identification.

9. A frequency identification apparatus according to claim 8 wherein the computing device normalizes the set of optical power measurements with respect to the reference optical power measurement generating a set of normalized optical power measurements, and performs a comparison between the set of normalized optical power measurements and points of the constellation to generate the frequency identification.

10. A frequency identification apparatus according to claim 9 wherein the comparison is a Euclidean smallest distance comparison.

11. A frequency identification apparatus according to claim 3 further comprising:
a data table containing a parameterized constellation of the frequency identification apparatus, said parameterized constellation having a set of parameters;
wherein the computing device processes the parameterized constellation of the frequency identification apparatus using a set of equations and said set of parameters to generate the frequency identification.

12. A frequency identification apparatus according to claim 11 wherein the computing device normalizes the set of optical power measurements with respect to the reference optical power measurement generating a set of normalized optical power measurements, generates points of the constellation by use of the set of equations and the set of parameters of the parameterized constellation, and performs a comparison between the set of normalized optical power measurements and points of the constellation to generate the frequency identification.

13. A frequency identification apparatus according to claim 12 wherein the comparison is a Euclidean smallest distance comparison.

14. A method of identifying a frequency of an optical signal having a frequency including:
producing a set of filtered optical signals from portions of said optical signal, the set of filtered optical signals having a corresponding set of filtered optical signal powers, said producing the set of filtered optical signals being such that when the frequency of the optical signal is any first frequency, the set of filtered optical signal powers together with a power of an unfiltered portion of the optical signal is different from the set of filtered optical signal powers together with the power of the unfiltered portion of the optical signal when the frequency of the optical signal is any second frequency different from said first frequency;
measuring the set of filtered optical signal powers and generating a corresponding set of optical power measurements; and
measuring the power of the unfiltered portion of the optical signal and generating a corresponding reference optical power measurement;
wherein the set of optical power measurements and the reference optical power measurement uniquely identify the frequency of the optical signal.

15. A method according to claim 14 wherein the step of producing a set of filtered optical signals includes producing at least one slope filtered optical signal.

16. A method according to claim 14 further including:
processing said set of optical power measurements and said reference optical power measurement to generate a frequency identification of the frequency of the optical signal.

17. A method according to claim 14 further including:
generating said portions of the optical signal from the optical signal;
generating said unfiltered portion of the optical signal from the optical signal;
providing said portions of the optical signal for said producing a set of filtered optical signals; and
providing said unfiltered portion of the optical signal for said measuring the power of the unfiltered portion of the optical signal.

18. A method according to claim 16 further including:
processing a constellation including normalizing the set of optical power measurements with respect to the reference optical power measurement generating a set of normalized optical power measurements, and performing a comparison between the set of normalized optical power measurements and points of the constellation to generate the frequency identification.

19. A method according to claim 18 wherein the comparison is a Euclidean smallest distance comparison.

20. A method according to claim 16 further including:
processing a parameterized constellation having a set of parameters, including normalizing the set of optical power measurements with respect to the reference optical power measurement generating a set of normalized optical power measurements, generating points of the constellation by use of a set of equations and the set of parameters of the parameterized constellation, and performing a comparison between the set of normalized optical power measurements and points of the constellation to generate the frequency identification.

21. A method according to claim 20 wherein the comparison is a Euclidean smallest distance comparison.

22. A frequency locker apparatus for frequency locking and for frequency identification of an optical signal of a laser having a frequency comprising:
a plurality of optical filters for producing a set of filtered optical signals from portions of said optical signal, the set of filtered optical signals having a corresponding set of filtered optical signal powers, the plurality of optical filters being such that when the frequency of the optical signal is any first frequency, the set of filtered optical signal powers together with a power of an unfiltered portion of the optical signal is different from the set of filtered optical signal powers together with the power of the unfiltered portion of the optical signal when the frequency of the optical signal is any second frequency different from said first frequency;
an optical power measuring device for measuring the set of filtered optical signal powers and generating a corresponding set of optical power measurements, and for measuring the power of the unfiltered portion of the optical signal and generating a corresponding reference optical power measurement; and
a locking circuit for adjusting the frequency of the optical signal of the laser to a locking frequency and maintaining the frequency of the optical signal of the laser at the locking frequency as a function of the reference optical power measurement and some optical power measurements of the set of optical power measurements;
wherein the set of optical power measurements and the reference optical power measurement uniquely identify the frequency of the optical signal.

23. A frequency locker apparatus according to claim 22 wherein the plurality of optical filters comprises at least one slope filter.

24. A frequency locker apparatus according to claim 22 further comprising:
a computing device for processing said set of optical power measurements and said reference optical power measurement to generate a frequency identification of the frequency of the optical signal.

25. A frequency locker apparatus according to claim 24 further comprising:
a feedback circuit for controlling the frequency of the optical signal of the laser'so that it is within a locking acquisition range of the locking frequency, said feedback circuit controlling the frequency of the optical signal of the laser as a function of the frequency identification.

26. A frequency locker apparatus according to claim 22 wherein the optical power measuring device comprises a plurality of filter photodetectors for generating said corresponding set of optical power measurements from said set of filtered optical signals, and a reference photodetector for producing said reference optical power measurement from said unfiltered portion of the optical signal.

27. A frequency locker apparatus according to claim 22 further comprising:
a plurality of beam splitters for generating said portions of the optical signal from the optical signal and for generating said unfiltered portion of the optical signal from the optical signal, said plurality of beam splitters for providing said portions of the optical signal to said plurality of optical filters, and for providing said unfiltered portion of the optical signal, to the optical power measuring device.

28. A frequency locker apparatus according to claim 25 further comprising:
a plurality of beam splitters for generating said portions of the optical signal from the optical signal and for generating said unfiltered portion of the optical signal from the optical signal, said plurality of beam splitters for providing said portions of the optical signal to said plurality of optical filters, and for providing said unfiltered portion of the optical signal to the reference photodetector

29. A frequency locker apparatus according to claim 25 further comprising:
a walk-off reflector for generating said portions of the optical signal from the optical signal and for generating said unfiltered portion of the optical signal from the optical signal, said walk-off reflector for providing said portions of the optical signal to said plurality of optical filters, and for providing said unfiltered portion of the optical signal to the reference photodetector.

30. A frequency locker apparatus according to claim 24 further comprising:
a data tables containing a constellation of the frequency locker apparatus;
wherein the computing device processes the constellation of the frequency locker apparatus to generate the frequency identification.

31. A frequency locker apparatus according to claim 30 wherein the computing device normalizes the set of optical power measurements with respect to the reference optical power measurement generating a set of normalized optical power measurements, and performs a comparison between the set of normalized optical power measurements and points of the constellation to generate the frequency identification,

32. A frequency locker apparatus according to claim 31 wherein the comparison is a Euclidean smallest distance comparison.

33. A frequency locker apparatus according to claim 24 further comprising:
a data table containing a parameterized constellation of the frequency locker apparatus, said parameterized constellation having a set of parameters;
wherein the computing device processes the parameterized constellation of the frequency locker apparatus using a set of equations and said set of parameters to generate the frequency identification.

34. A frequency locker apparatus according to claim 33 wherein the computing device normalizes the set of optical power measurements with respect to the reference optical power measurement generating a set of normalized optical power measurements, generates points of the constellation by use of the set of equations and the set of parameters of the parameterized constellation, and performs a comparison between the set of normalized optical power measurements and points of the constellation to generate the frequency identification.

35. A frequency locker apparatus according to claim 34 wherein the comparison is a Euclidean smallest distance comparison.

36. A method of frequency locking a laser and identifying a frequency of an optical signal of the laser having a frequency comprising:
producing it set of filtered optical signals from portions of said optical signal, the set of filtered optical signals having a corresponding set of filtered optical signal powers, said producing the set of filtered optical signals being such that when the frequency of the optical signal is any first frequency, the set of filtered optical signal powers together with the power of an unfiltered portion of the optical signal is different from the set of filtered optical signal powers together with the power of the unfiltered portion of the optical signal when the frequency of the optical signal is any second frequency different from said first frequency;
measuring the set of filtered optical signal powers and generating a corresponding set of optical power measurements;
measuring the power of the unfiltered portion of the optical signal and generating a corresponding reference optical power measurement; and
adjusting the frequency of the optical signal of the laser to a locking frequency and maintaining frequency of the optical signal of the laser at the locking frequency as a function of the reference optical power measurement and some optical power measurements of the set of optical power measurements;
wherein the set of optical power measurements and the reference optical power measurement uniquely identify the frequency of the optical signal.

37. A method according to claim 36 wherein the step of producing a set of filtered optical signals includes producing at least one slope filtered optical signal.

38. A method according to claim 36 further including:
processing said set of optical power measurements and said reference optical power measurement to generate a frequency identification of the frequency of the optical signal.

39. A method according to claim 38 further including before the step of adjusting the frequency of the optical signal of the laser to the locking frequency and maintaining the frequency of the optical signal of the laser at the locking frequency:
controlling the frequency of the optical signal of the laser as a function of the frequency identification so that it is within a locking acquisition range of the locking frequency.

40. A method according to claim 39 wherein the step of controlling the frequency of the optical signal of the laser includes:
repeatedly powering up the laser so that it transmits said optical signal for a duration which is insignificant to the functioning of a telecommunications system, and varying the frequency of the optical signal of the laser as a function of the frequency identification until it is within locking acquisition range of the locking frequency.

41. A method according to claim 36 further including:
generating said portions of the optical signal from the optical signal;
generating said unfiltered portion of the optical signal from the optical signal;
providing said portions of the optical signal for said producing a set of filtered optical signals; and
providing said unfiltered portion of the optical signal for said measuring the power of the unfiltered portion of the optical signal.

42. A method according to claim 38 further including:
processing a constellation including normalizing the set of optical power measurements with respect to the reference optical power measurement generating a set of normalized optical power measurements, and performing a comparison between the set of normalized optical power measurements and points of the constellation to generate the frequency identification.

43. A method according to claim 42 wherein the comparison is a Euclidean smallest distance comparison.

44. A method according to claim 38 further including:
processing a parameterized constellation having a set of parameters, including normalizing the set of optical power measurements with respect to the reference optical power measurement generating a set of normalized optical power measurements, generating points of the constellation by use of a set of equations and the set of parameters of the parameterized constellation and performing a comparison between the set of normalized optical power measurements and points of the constellation to generate the frequency identification.

45. A method according to claim 44 wherein the comparison is a Euclidean smallest distance comparison.
